(19) United States
(12) Patent Application Publication
(10) Pub. No.: US 2005/0100340 A1
(43) Pub. Date: May 12, 2005

(54) Packet switching system

(75) Inventor: Shinji Nishimura, Tokyo (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 10/978,411

(22) Filed: Nov. 2, 2004

(30) Foreign Application Priority Data
Nov. 11, 2003 (JP) 2003-380631

(51) Int. Cl. H04B 10/00

(52) U.S. Cl. 398/135

(57) ABSTRACT

Disclosed here is a BP type architecture packet switching system that prevents delay of packet forwarding in the system itself while keeping the system configuration flexibility. Furthermore, an optical BP can be used to reduce both of the number of optical signal line parts and the manufacturing cost. In the packet switching system, a back plane (BP) board is used between a network processor and a link circuit, not between a switch and a network processor when connection is established among a switch, a network processor, and a link circuit.

### CLAIM OF PRIORITY

The present invention claims priority from Japanese application JP 2003-380631 filed on Nov. 11, 2003, the content of which is hereby incorporated by reference into this application.

### FIELD OF THE INVENTION

The present invention relates to an internal structure for routers and switches used for computer networks and more particularly to a packet switching system to be connected to optical signal paths.

### BACKGROUND OF THE INVENTION

Packet switching systems used for communications through computer networks have been used widely in various markets. They are referred to as routers and switches separately in their application fields. Network traffics are now expanding year by year along with the widespread of such broadband connections as ADSL, FTTH, etc. And, along with the widespread, the markets have come to require packet switching systems enabled for faster forwarding processes of received packets.

Each conventional packet switching system is structured so that a routing table, a network processor, etc. used for forwarding received packets are mounted on a circuit board referred to as a line card and a plurality of such line cards are connected to each another in a switch fabric structure. The switch fabric structure is mounted on a printed circuit board referred to as a switch card, which is different from the line card. And, a back plane board is used for the connection between the switch card and the line card. The back plane board means just a wiring for connecting a plurality of function modules. Concretely, it is a printed circuit board having an electrical signal wiring formed on itself. In such a packet switching system, if the traffic of a connected communication line increases significantly, the number of network processors, that is, the number of line cards are increased to cope with an increase of the packets to be processed.

In addition to the above-described parts used for forwarding packets, a line card may also include a link circuit on the same circuit board. The link circuit is used to transmit packets to/from a line card. The name of the link circuit is originated from its function for linking a line card to an external device. The link circuit may be mounted on a circuit board differently from that of the packet forwarding circuit. The official gazette of JP-A No. 64542/2002 discloses such a packet switching system in its FIG. 1. In the packet switching system, a line card for transmitting/receiving packets, a network processor card for routing packets, and a forwarding engine card for forwarding packets are connected to each another through a cross-bar switch. The number of link circuits/network processors is identical to the number of links (for example, 8 links for an 8-link router/switch) while only one switch is usually provided for a system. (The switch may be composed of a plurality of chips.) This is why a link circuit and a network processor are usually mounted on the same circuit board.

Because a line card that can function to forward packets by itself is connected to an object device through a switch card as described above, the packet switching system comes to cope with an increment/decrement of the connected line traffic or changes of network connections.

[Patent Document 1] Official Gazette of JP-A No. 64542/2002

In each conventional packet switching system, the communication traffic between a network processor used for routing packets to be forwarded and a switch has been required to be wider than the communication traffic between the network processor and a link circuit. In each present packet switching system, however, a switch fabric is usually connected to 4 to 8 network processors, so that the communication speed between a switch and a network processor is required to be set faster enough to cope with the number of connected network processors. Otherwise, the switch—network work section becomes a bottleneck to cause a congestion in the internal packet forwarding process. For example, in an Ethernet (registered trade mark) 1 GB/sec link circuit, the transmission speed between the link circuit and the network processor is set at 1 GB/sec while that between the network processor and the switch fabric card is required to be set at 2 GB/sec to 1.5 GB/sec that is 20% to 50% higher than that between the link circuit and the network processor. Because of this 20% to 50% faster connection, the data processed in the network processor is forwarded to the switch fabric card with no delay.

And, an increase in the signal speed frequency of the line connected to each device invites an increase of the signal transmission loss caused by a dielectric loss and a conductor loss of the material used for the signal lines included in the wiring. In the conventional packet switching system, however, it cannot be avoided to extend the network processor—switch line to a certain length, since the line card and the switch card are connected to each other through a back plane board.

On the other hand, now that signals are processed faster and the processing capacity is expanded significantly, employment of a back plane board that uses optical signal lines is expected to be favorable in the future. In such an optical back plane board, electrical signals to be exchanged between a network processor and a switch are converted to optical signals that are to be inputted/outputted as they are. And, the use of such optical signals enables fast signal wiring at a longer distance on the back plane board than when electrical signal lines are used. In addition, the use of optical fiber and optical fiber connectors that are smaller in size than electrical signal lines and electrical signal connectors come to be enabled.

However, if an optical back plane board is used in a conventional packet switching system, a bottle-neck might occur between each network processor and the switch. This is because a photoelectric converter is required to be provided in the optical back plane board between the line card and the switch card in such a case. In other words, two conversion operations are required between the network processor and the switch; conversion of electrical signals to optical signals and conversion of optical signals to electrical signals. And, this bottle-neck portion causes delay of the packet forwarding in the packet switching system.

To avoid such problems, there is a structure considered to integrate all of the link circuits, the network processors, and the switch in a device without using the back plane structure. In that connection, this integrated structure looses the flexibility for replacing the link circuit with another, so that the structure has not been employed for systems except for small sized ones.

### SUMMARY OF THE INVENTION

Under such circumstances, it is an object of the present invention to solve the above conventional problems and provide a packet switching system having a device architecture enabled flexibly to cope with an expansion of communication traffic and changes of the communication environment without causing any congestion in internal forwarding processes of packets.

According to the present invention, a link card is just mounted at each line card and the network processors and the switch are mounted on the same card to solve the above conventional problems. Each line card and the switch card are connected to each other through a back plane board.

This is why the present invention can realize a packet switching system that can cope with an expansion of the communication traffic and even changes of the communication environment flexibly without causing any congestion in the forwarding of packets in the system itself. Particularly, the effect of the present invention that employs the optical back plane board is remarkable. And, in the packet switching system of the present invention, the number of optical transceiver devices used for optical input/output operations, required when the optical back plane-board is used, is reduced more significantly than the conventional structure. And accordingly, the cost reduction is realized favorably, as well as both requirements of size reduction and high performance are satisfied in the packet switching system.

### BRIEF DESCRIPTION OF THE DRAWINGS

FIG. 1 is a concept chart of a network system that includes two line cards and one switch card;

FIG. 2 is a structure of a switch board that includes a switch and a plurality of network processors;

FIG. 3 is a structure of an optical back plane board;

FIG. 4 is a connection topology of an 8-link circuit;

FIG. 5 is a connection topology of a 16-link circuit;

FIG. 6 is a connection topology of a 64-link circuit;

FIG. 7 is a table of optical I/O reduction effects achieved by a transceiver circuit of the present invention;

FIG. 8 is a schematic view of the 16-link circuit;

FIG. 9 is a back plane structure of the 16-link circuit;

FIG. 10 is a schematic view of another 16-link circuit;

FIG. 11 is a back plane structure of another 16-link circuit;

FIG. 12 is a block diagram of a switch card package in which four network processors and one switch are mounted;

FIG. 13 is a block diagram of a switch card package in which 8 optical transceiver circuits, four network processors, and one switch are mounted; and

FIG. 14 is a concept chart of a network system in which two line cards and one switch card are mounted and connected to each another through electrical signal lines.

### DETAILED DESCRIPTION OF THE PREFERRED EMBODIMENTS

### First Embodiment

Hereunder, the preferred embodiments of the present invention will be described with reference to the accompanying drawings. In the following description, concrete values will be used. However, they are just examples to make it easier to understand the description; the embodiments will never be limited by those values.

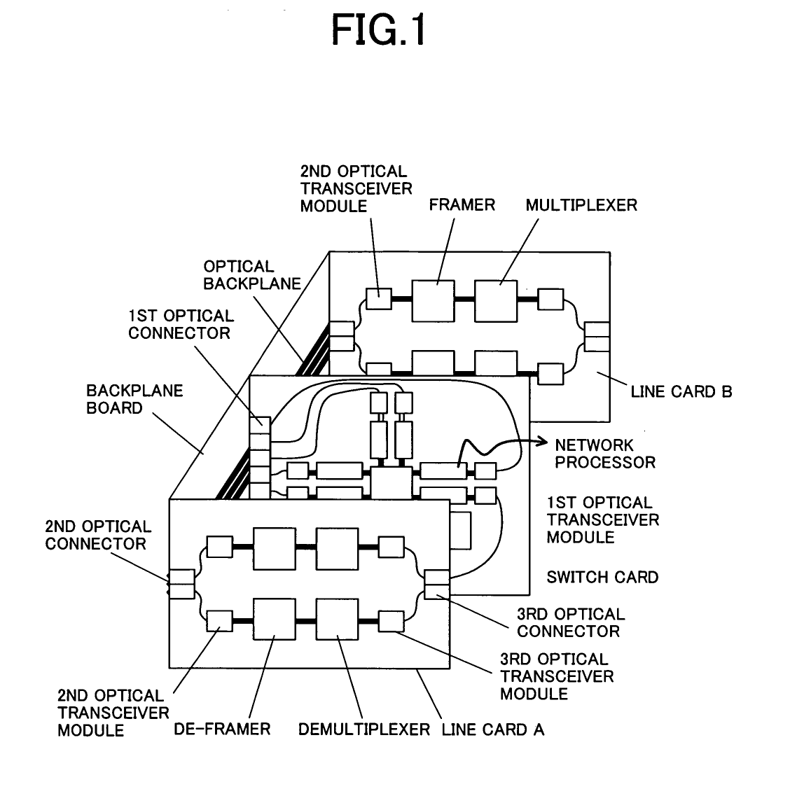

In the following embodiments, a plurality of line cards and one switch card are used to configure a network router/switch. And, an optical back plane board is used for the connection between each line card and the back plane board. FIG. 1 shows a packet switching system that includes two line cards A and B structured identically are connected to the switch card. The mounted parts are the same between the line cards A and B. The switch card uses an optical back plane board. In addition, the packet switching system in this embodiment is expected to be connected to WDM optical signal lines and the line cards A and B are provided with a WDM communication interface respectively. And, although not shown in FIG. 1, the back plane board, the line cards A and B, and the switch card are actually housed in a cabinet.

In the case of a conventional router switch, a link circuit and a plurality of network processors are mounted on the same printed circuit board while the switch card is mounted on a different board. Just like the packet switching system shown in FIG. 1, a link circuit is just mounted at each line card while the network processors and the switch are integrated in a different board to reduce the path in length between the switch and each network processor than between the link circuit and each network processor. This prevents delay of the packet forwarding to be caused by the connection between each network processor and the switch and that connection is expected as a bottleneck of the system operation. On the other hand, the flexibility that enables the link circuit to be replaced with a more proper one according to the use environment is retained.

Furthermore, in the packet switching system in this embodiment, an optical back plane board is used. And, if the optical backplane board is used for the connection between each network processor and the switch, a plurality of optical data transmission devices are required to be disposed in parallel to assure the required communication capacity of the back plane board. For example, in order to realize a link speed of 10 GB/sec, a data transfer speed of 12 to 15 GB/sec is required between each network processor and the switch. And, if four channels of 2.5 GB/sec signal lines are used to realize a data transmission capacity of 10 GB/sec in a link circuit, 5 to 6 lines of a transmission speed of 2.5 GB/sec are required to be used in parallel between each network processor and the switch. In other words, 5 to 6 optical lines are used in parallel between each network processor and the switch and the optical transceiver module is required to be configured with use of 5 to 6 photoelectric converters in the optical back plane board between each line card and the switch card in accordance with the number of optical cables. The optical device is higher in cost than electrical signal lines, so it should be avoided to use many optical transmission paths in parallel in an optical back plane board so as to prevent an increase of the system manufacturing cost. To avoid this problem, the line between each network processor and the switch should not be provided in an optical back plane board like the conventional structure. Instead, the line between each network processor and the link circuit should be provided in the optical back plane board, since the communication speed in that case can be set lower than that between each network processor and the switch. As a result, the number of optical transceiver devices used for the lines of the back plane board can be reduced more than the lines between each network processor and the switch. And, because each network processor and the switch are connected to each other so that data processed by each network processor is transferred to the network processor in the next step through the switch without delay, a higher communication speed is required more between each network processor and the link circuit.

Next, the line cards A and B will be described. One line card is configured by third optical connectors for transmitting/receiving optical signals to/from an external network, two link circuits connected to the third optical connectors, and second optical connectors provided at the back plane board, which are all mounted on a circuit board. Each link circuit is provided with a multiplexer, a framer, and second optical transceiver modules. The link circuit is varied freely in structure so as to meet the required communication distance and the communication protocol in use. For example, nine standardizing techniques are available for the 10 GB Ethernet (registered trademark). Consequently, the link circuit is not used fixedly; it is used flexibly so that it is replaced with a more proper one in accordance with changes of the use environment. Although not shown in FIG. 1, the cabinet that houses the packet switching system shown in FIG. 1 is provided with an external line terminal, which functions as a physical line interface with an external communication line. The terminal is connected to each of the third optical connectors of the line cards A and B. Optical signals (speed: 10 GB/sec or so) received from external are converted to electrical signals (speed: 10 GB/sec or so) by the external signal transmitting/receiving third optical transceiver module through one of the two third optical connectors. The signals received from the third optical transceiver module are converted to 2.5 MB/sec×4-bit signals by a 1:4 multiplexer. Extracted 4-bit signals are aligned in Ethernet (registered trademark) frames by the framer, then converted to optical signals by the second optical transceiver module, then transmitted to the optical back plane board through the two second optical connectors.

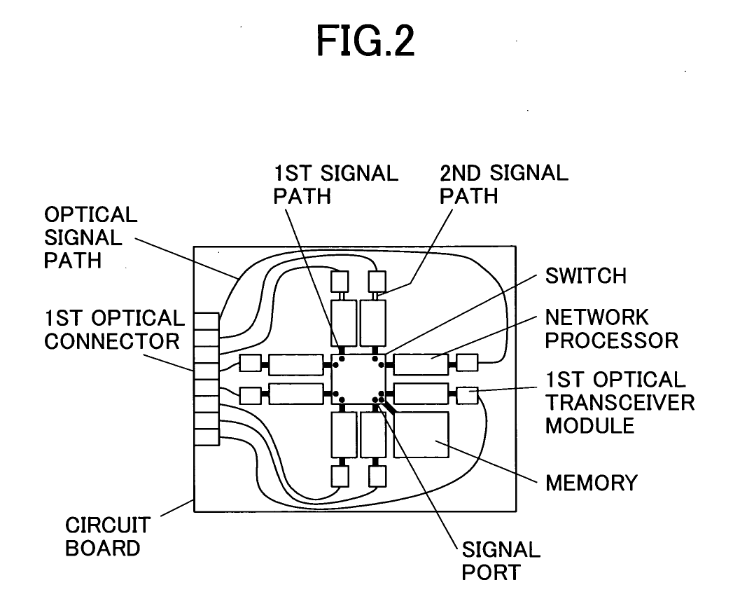

FIG. 2 shows a detailed structure of the switch card shown in FIG. 1. The switch card in this embodiment includes first optical connectors for transmitting/receiving signals to/from an optical back plane board respectively, network processors, a memory for storing a routing table, first optical transceiver modules for converting optical signals received from the first optical connectors to electrical signals or electrical signals received from the network processors to optical signals, a switch for enabling the network processors to be connected to each another, optical signal lines used for the connection between the first optical connectors and the first optical transceiver modules, first signal paths used for the connection between the switch and each network processor, and second signal paths used for the connection between network processors and first optical transceiver modules. The first and second signal paths are electric lines used to drive the network processors electrically. Although the first signal paths are electric lines, the length can be reduced more significantly than when the switch is connected to each network processor through a back plane board or optical back plane board. Consequently, this structure can prevent delay of signals effectively. Optical fiber is used for the connection between those devices. The memory contains a routing table, as well as programs to be executed by the network processors. The routing table and those programs may be stored in different memories separately.

As shown in FIG. 2, the switch is provided with a plurality of line pins, each of which functions as a port. In this embodiment, eight ports are required to meet the number of network processors and some of the plurality of line pins are allocated to the eight ports. In this embodiment, the same number of line pins are allocated to each of the first signal paths. The communication capacity is thus the same among all the first signal paths. Consequently, the variation of the communication capacity between each network processor and the switch is minimized to prevent delay of packet forwarding between each specific network processor and the switch.

In this embodiment, the network processors are disposed around the switch. Such disposition is referred to as star-type disposition. This star-type disposition enables the path length to be almost the same between each network processor and the switch. Here, “almost” means that it is not the same in length physically, but it may be taken as approximately the same from the standpoint of signal passing through the signal path. For example, the length of the optical signal line between a first optical connector and a first optical transceiver module is varied fairly depending on the disposition place on the switch card of the first optical transceiver module. All the first signal paths may be considered to be almost the same in length when compared with the variation of the length among the optical signal lines.

Because the length is set almost the same among the first signal paths, the variation of the communication capacity between each network processor and the switch, as well as the signal speed variation between lines are reduced respectively. This is why the structure of the synchronization circuit is simplified more than the optical module part when signals are transmitted between each network processor and the switch. The star-type disposition of devices will be described in detail later.

Signals transmitted to the switch card through the optical back plane board are subjected to an address information searching/setting process and a route switching process carried out at the switch shown in FIG. 2 respectively. Signals from the optical back plane board (2.5 GB/sec×4 channels from one line card) are input/output to/from the switch through the optical connectors shown in FIG. 2. Then, the signals are transmitted/received to/from the optical connectors through optical signal paths (4-channel optical fiber) provided on the board. The 4-channel electrical signals from the optical transceiver modules are subjected to an address information searching/setting process by network processors, then input to the switch through signal lines of 2.5 GB/sec×6 channels to be subjected to a route switching process, then output. And, because the signal transmission capacity between each network processor and the switch is expanded from 2.5 GB/sec×4 channels to 2.5 GB/sec×6 channels per signal line, the transmission capacity between each network processor and the switch is secured, so that signals processed by the network processors are passed over to the switch at just a slight delay. In the switch, the route switching is done according to the address information stored in the memory.

In this embodiment, the memory is also connected to each network processor through a first signal path and the switch. Consequently, the path length comes to be almost the same between the memory and each network processor (equal length wiring). In this embodiment, only one memory is provided and the same routing table is shared among the network processors. Consequently, each network processor refers to the same memory when forwarding received packets. Because the memory is connected to all the network processors at an equal line length such way, it is possible to suppress the variation of the speed of accessing the memory from each network processor when reading information therefrom. As a result, in the packet switching system, the speed variation among the network processors that access the memory is suppressed; thereby the characteristic variation among the connectors is also suppressed.

There are two methods of optical signal wiring from an optical connector to an optical transceiver module on a board. Those methods are employed for both of the line cards and the switch card; one method using optical fiber and the other method using an optical waveguide. The method that uses optical fiber has an advantage of low signal transmission loss while the mounting capacity comes to be larger than the optical waveguide structure, because it is structured separately from the back plane board. On the other hand, the structure that uses an optical waveguide has an advantage, of uniting both back plane board and optical signal lines into one, so that its mounting capacity comes to be small. However, the method has a problem that the transmission loss in the optical signal line is larger than that of the optical fiber. If fast optical signals are to be used, the optical fiber that is low in transmission loss should be used to secure a high receiving margin for the receiver.

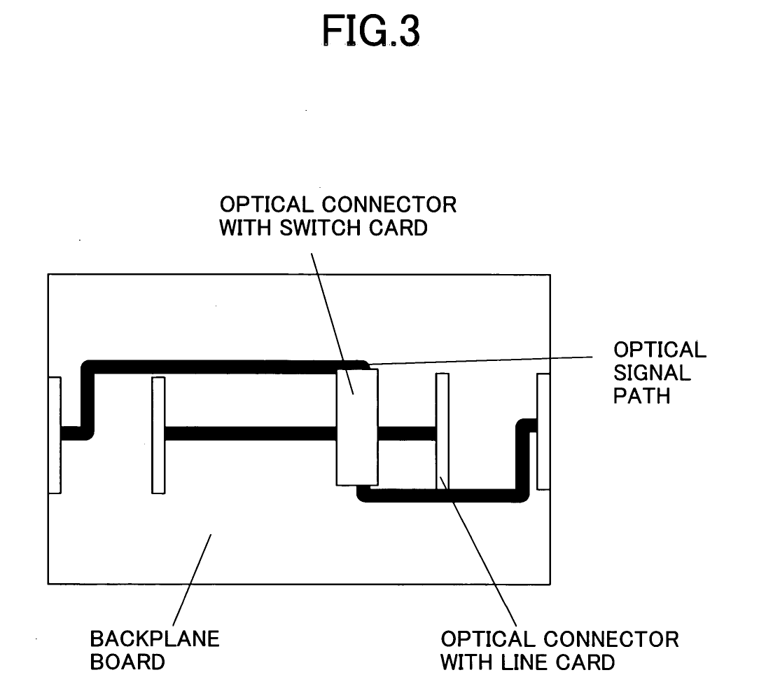

FIG. 3 shows a block diagram of an optical back plane board. In FIG. 3, the white large rectangle is an optical switch card connector and four thin rectangles are optical line card connectors. Each black line between those rectangles is an optical signal line. The optical back plane board is connected to four line cards and one switch card. One line card includes two link circuits. If all the four line cards are mounted, the router/switch device comes to have 8 inputs and 8 outputs.

As described with reference to FIGS. 1 through 3, because a link circuit replaceable with another in accordance with the use environment is disposed at each line card and the network processors and the switch are integrated on the same printed circuit board, the packet switching system comes to be able to suppress delay of internal packet forwarding effectively while retaining the system configuration flexibility with which each link circuit is replaceable with another in accordance with the use environment. Such system configuration flexibility is very important, particularly in large sized router/switch devices.

Furthermore, an optical back plane board is used for the connection between each link circuit and each network processor. Consequently, the number of optical signal transmitting/receiving devices can be reduced more than when an optical back plane board is used for the connection between the switch and each network processor.

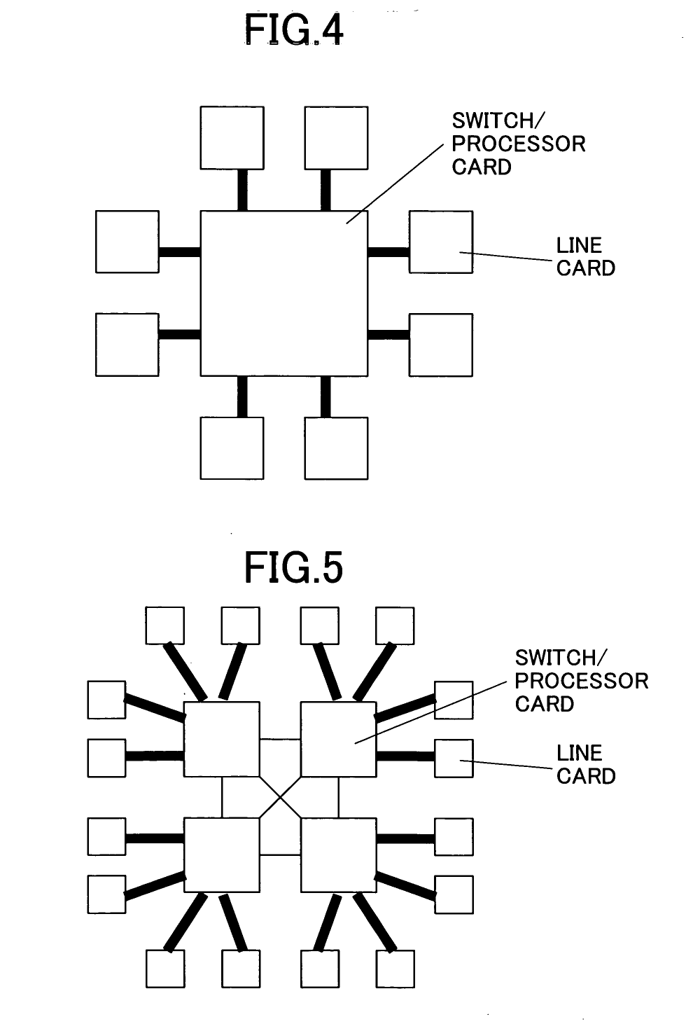

FIG. 4 shows an explanatory chart for describing the definition of a star-type device connection method. In FIG. 2, the star-type device connection method is employed for the connection between the switch and each network processor. In FIG. 4, however, the method is employed for the connection between a switch card and line cards. The star-type device connection method enables a plurality of line cards to be disposed around one switch card at an equal distance therebetween. If the communication distance between line cards is equal in a system and the number of switch ports and the number of line cards in the system are almost equal, the number of parts can be reduced, thereby the system configuration is simplified.

The 8-link star-type device connection method is effective to reduce the number of lines among devices.

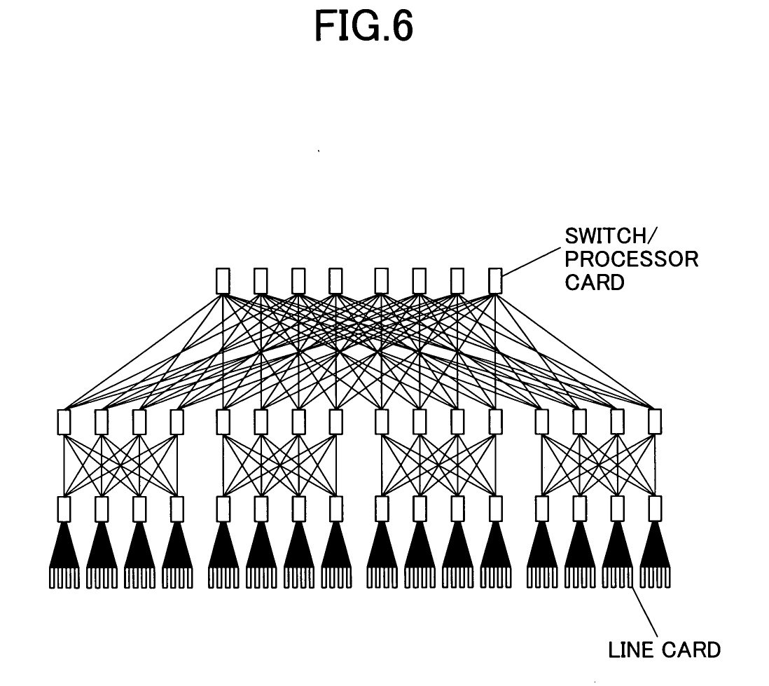

FIGS. 5 and 6 show schematic diagrams of a variation of the star-type device connection method and a fat tree device connection method. In the case of the 16-input/output configuration topology and the 64-input/output configuration topology, the star-type or fat tree configuration shown in FIGS. 5 and 6 can reduce the number of lines between devices. In FIGS. 5 and 6, the switch is disposed over a plurality of optical back plane boards, so that the switches are connected to each other through an optical back plane board. The fat tree structure means a structure in which cross-bar switches are connected to each another in a tree-like pattern as shown in FIGS. 5 and 6. The fat tree structure has an advantage that the communication capacity between each line card and the switch can be scaled up in accordance with an increase of the number of line cards and the number of switch cards to be increased to cope with the scale-up can be suppressed. On the other hand, the star-type structure can dispose devices with less switch cards when the number of line cards is within 8 to 16. If the number of line cards increases to 64, 128, . . . , the fat tree structure is more favorable than the star-type structure, since the fat tree structure requires less switch cards without reducing the communication capacity in the system, thereby the system cost is reduced.

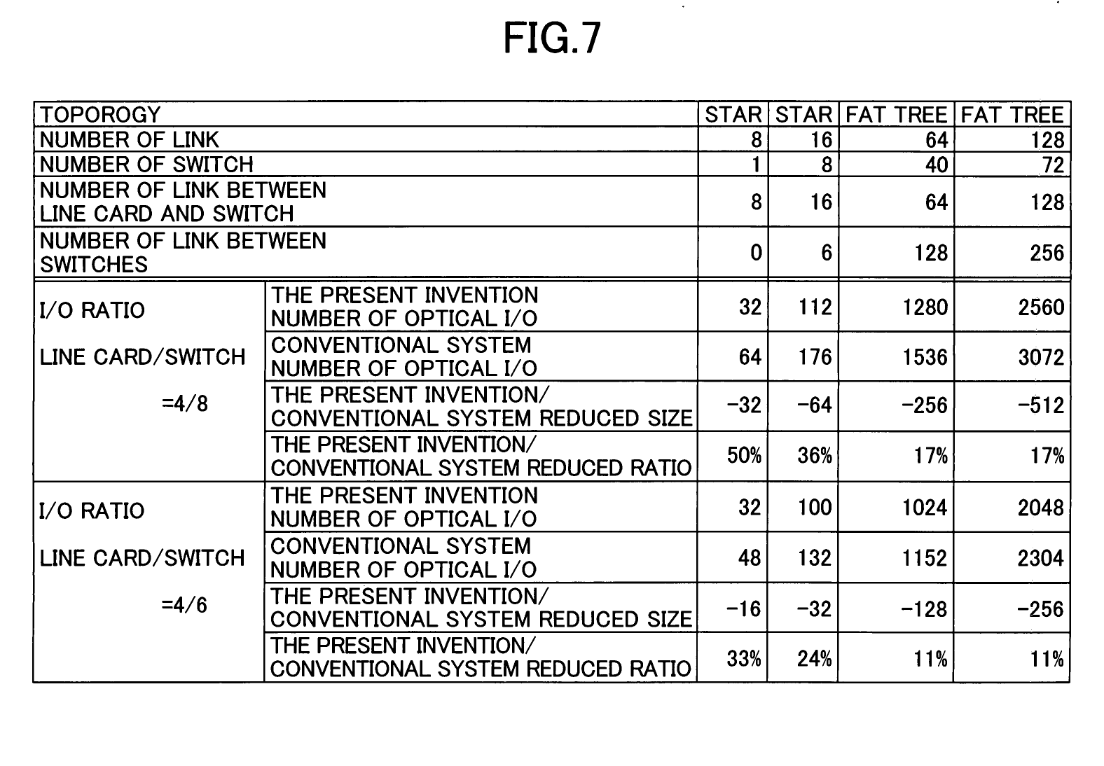

FIGS. 4 through 6 show cases in which conventional network processors and link circuits are mounted on the same line card respectively. And, FIG. 7 shows a result of comparison among those cases with respect to which of the cases will be able to reduce the number of optical transceiver devices. In this trial calculation, it is assumed that the switch card includes 8 connectors. In the trial calculation, it is assumed that four parallel links are provided between one line card and one network processor. And, the total number of devices to be mounted in an optical I/O apparatus is compared between a new invention (parallel optical I/O links are assumed for the connection between a line card and a network processor) and an old invention (parallel optical I/O links are assumed for the connection between a network processor and a switch) with respect to two cases; in one case, 8 parallel links are assumed between one network processor and one switch and in the other case, 6 parallel links are assumed between one network processor and one switch. For example, in the case of a switch consisting of 8 links, 8 line cards and one switch card are used. If four lines (links) are used for one line card and 8 lines (links) are used for one switch, the new invention uses a total of 32 (4×8) optical inputs/outputs for the connection to the switch while the old invention uses 64 optical inputs/outputs (8×8) for the connection to the switch. The difference between the new invention and the old invention with respect to the number of optical inputs/outputs thus becomes 32 optical inputs/outputs. Consequently, the new invention reduces the number of optical inputs/outputs by 50% from those of the old invention. Similar comparisons are also made for the following four cases; 8 links, 16, links, 64 links, and 128 links. The number of lines between one link circuit and one network processor is assumed to be 4 and the number of lines (links) between one network processor and one switch is assumed to be two types (8 lines and 6 lines). When the number of lines is less, the number of links between switches is also less, so that the optical inputs/outputs are reduced effectively in this embodiment (in the case of 8 links, 30 to 50% can be reduced) If the number of lines increases, however, the number of links between switches through optical inputs/outputs also increases, so that the percentage of the number of optical links between the link circuit and the network processor goes lower relatively. Consequently, the 128-link case can reduce the optical inputs/outputs by 11 to 17%. In that connection, however, the real number of optical inputs/outputs to be reduced becomes as many as a few hundreds.

### Second Embodiment

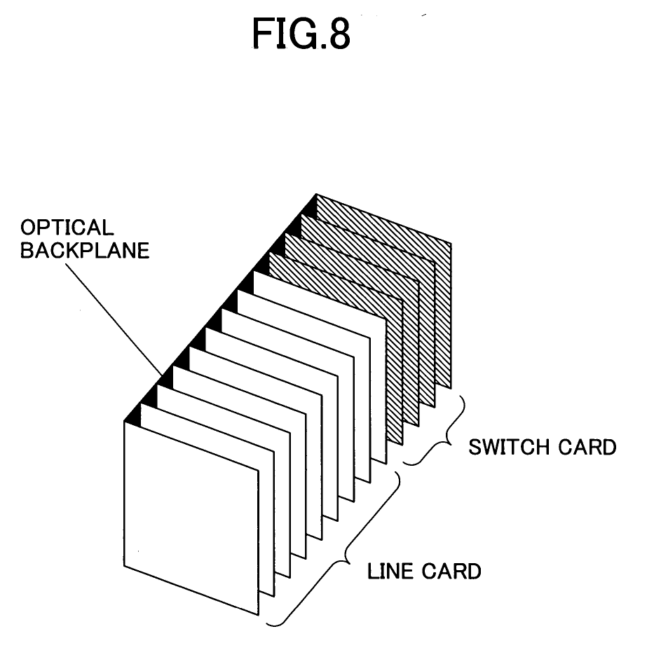

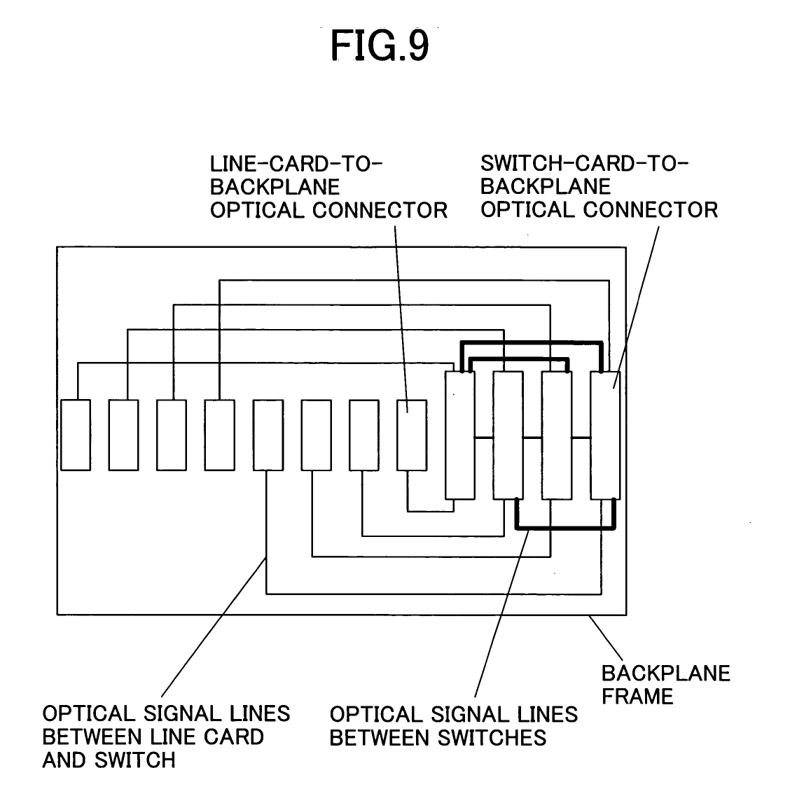

FIG. 8 shows a packet switching system configured by connecting the line-cards and the switch cards in the fat tree structure shown in FIG. 6. The system has 16 inputs and 16 outputs. FIG. 8 shows a top view of the optical back plane board shown in FIG. 9; the top view is seen from a direction for inserting the cards in the board. The large four rectangles are switch-card-to-backplane optical connectors to which the switch cards are connected and the eight small rectangles are line-card-to-backplane optical connectors to which line cards are connected. Each thick solid line is an optical signal line between switch cards and each thin line is an optical signal line between a line card and a switch. One line card includes two link circuits. One switch card includes one switch consisting of 8 inputs and 8 outputs. The network topology is the star-type one. The back plane board employs this star-type line structure that uses optical signal lines. Four channel optical signal lines are used between one line card and one switch and 6 optical signal lines are used between switches. One optical signal line passes optical signals of 2.5 GB/sec. The data communication capacity between one line card and one switch is 10 GB/sec and that between switches is 15 GB/sec.

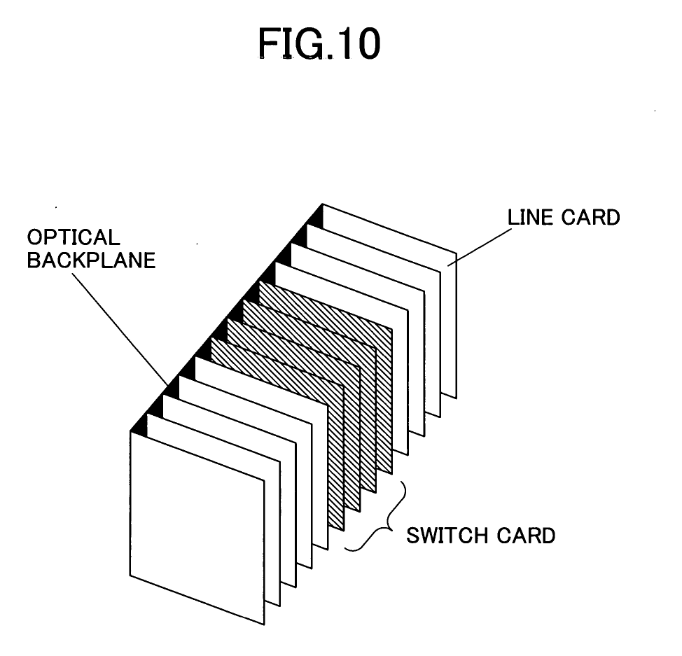

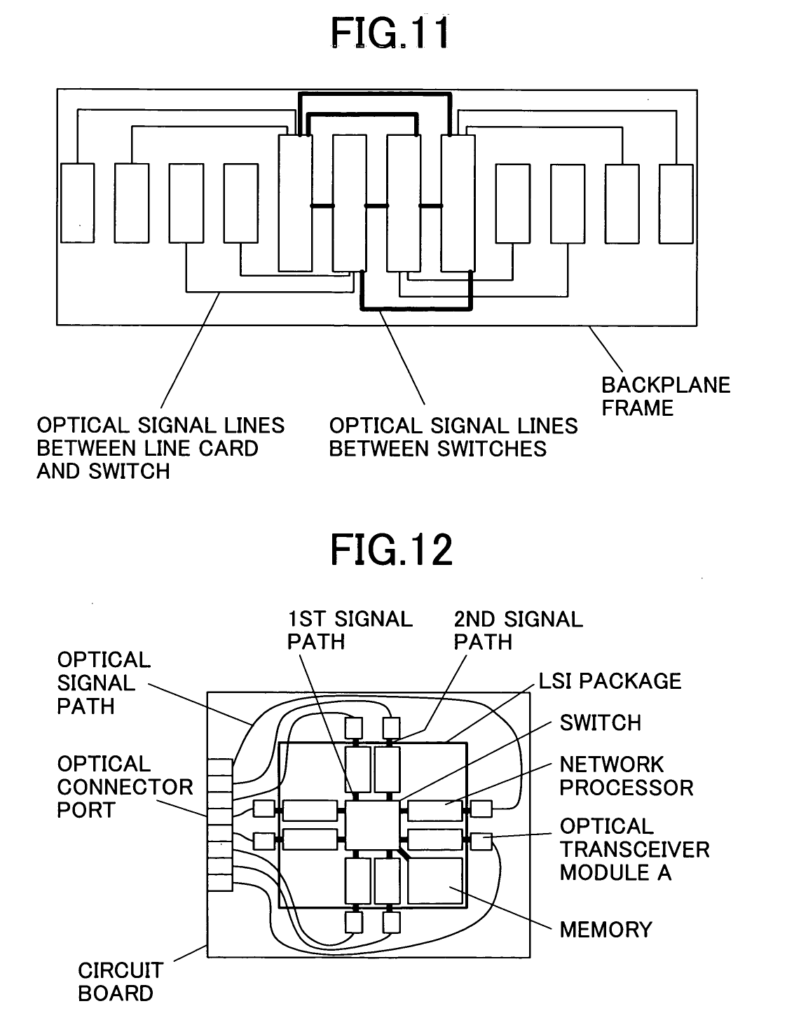

FIG. 10 shows another configuration of the packet switching system in which line cards and switch cards are connected to each another in the fat tree structure. Unlike the card disposition shown in FIG. 8, all the switch cards are disposed in the center portion of the optical back plane board shown in FIG. 9. FIG. 11 shows a top view of the packet switching system, in which the back plane board is seen from the card inserting direction. The names of the components in FIG. 11 are the same as those shown in FIG. 9. In the configuration shown in FIG. 11, switch-card-to-backplane optical connectors are disposed in the center portion of the back plane board and line card optical connectors are disposed symmetrically about the switch-card-to-backplane optical connectors. Such a card disposition enables the optical signal lines (line density) to be disposed at equal pitches on the optical back plane board. Consequently, the back plane board can be reduced in height; thereby the packet switching system can also be reduced in size.

### Third Embodiment

Just like the first embodiment, in the packet switching system shown in this third embodiment, network processors, a switch, and back plane communication optical transceiver devices are disposed on the same board. Although the network processors and the switch are disposed in different packages separately in the first embodiment (multi-chip packaging), those are disposed in the same package as shown in FIG. 12. In this third embodiment, the optical transceiver devices are disposed in a different package and all those packages are disposed around the package in which the switch and the network processors are mounted. Because of such a multi-chip packaging, each package is reduced in volume and the line distance between the packages is reduced, thereby the loss of the transmission signals to increase in accordance with an increase of the frequencies is suppressed.

Furthermore, because the network processors and the switch are disposed in the same package, the line distance between each network processor and the switch is reduced more than when they are disposed in different packages. The same bus line length is also assumed among devices. It is also possible to dispose a memory connected to each network processor together with the network processors and the switch in the same package to assume the direct connection between the memory and each network processor without using the switch. Because the memory is disposed together with the network processors such way, the line distance between the memory and each network processor is reduced, thereby fast input/output operations are realized easily.

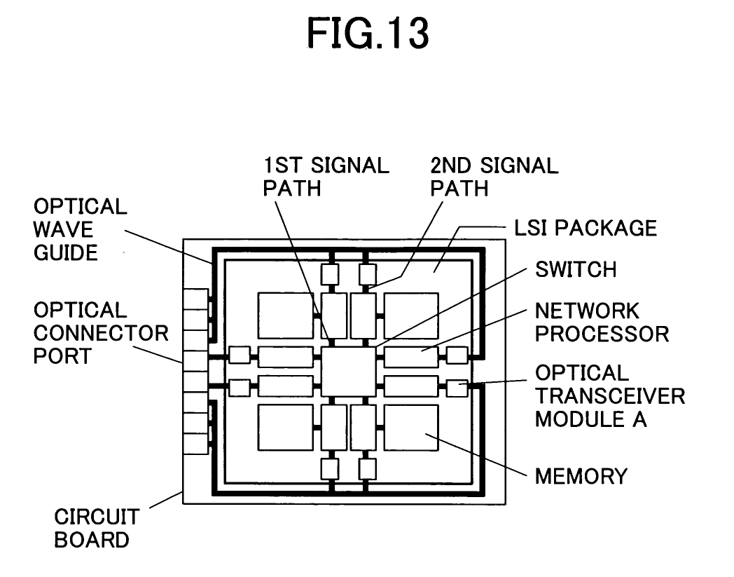

FIG. 13 shows still another configuration of the packet switching system in which the network processors, the switch, and 8 optical transceiver devices are disposed in the same package (multi-chip packaging). The network processors, the switch, and 8 optical transceiver devices are disposed in different packages in the first embodiment. And, because the switch, the network processors, and the optical transceiver devices are disposed in the same package such way (multi-chip packaging), the package can be reduced in volume and the line distance between those devices is reduced. The loss of the transmission signals to be increased by an increase of frequencies is also suppressed. The LSI package thus comes to have optical signal connectors; thereby the package is suitable for fast input/output operations of large capacity signals. In the case of the multi-chip package shown in FIG. 13, the memory is also disposed together with the network processors and the switch in the same package so that the memory is connected to each network processor directly. Because the memory is packaged such way, the line distance between the memory and each network processor is reduced, thereby speeding up input/output operations. Furthermore, in the example of the multi-chip packaging shown in FIG. 13, which differs from the configuration shown in FIG. 12, optical waveguides formed on the circuit board are used as optical signal lines. This method can also reduce the package in volume.

### Fourth Embodiment

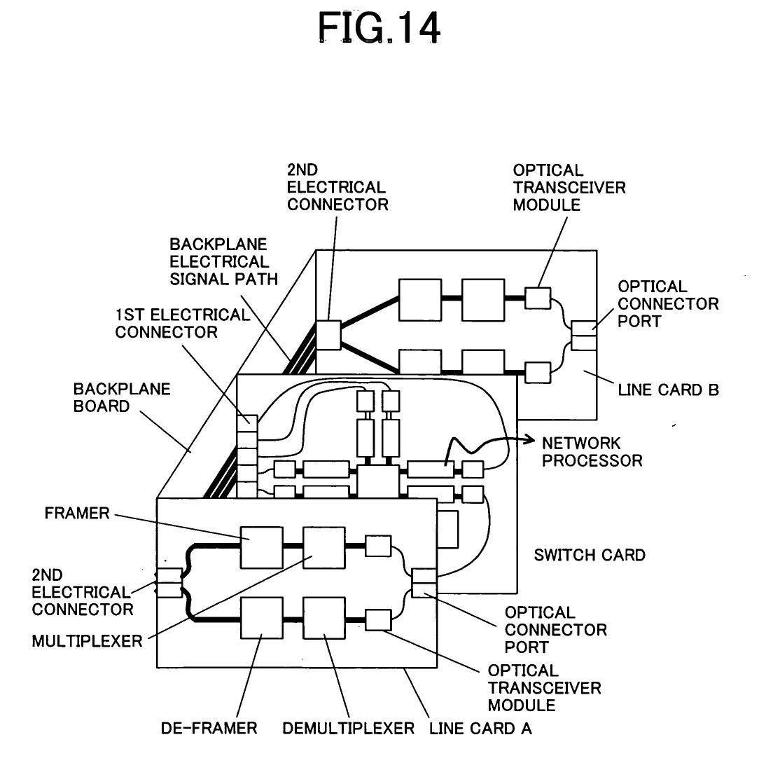

This fourth embodiment is the same as the first embodiment in that the network processors and the switch are disposed on the same board. However, the configuration in this fourth embodiment may be modified so that electrical signal lines are used for the connection between line cards and network processors without using optical signal lines through optical transceiver devices. FIG. 14 shows such an embodiment of the packet switching system in which an electric line back plane board is used; no optical signal line is used. In this fourth embodiment, a first electrical signal connector is used as a connection port between the switch card and the back plane board and a second electric connector is used as a connection port between the line card A/B and the back plane board. Although optical connectors are used as communication ports at the front side of the line card A/B, this is because WDM signal paths are expected as object communication lines. And, this is why the line card A/B comes to include a demultiplexer for demultiplexing WDM input signals and a multiplexer for multiplexing forwarded packets on WDM signals. If a target communication line is not an optical signal path, no such WDM multiplexer/demultiplexer is required.

Conventionally, network processors and circuits on line cards are mounted on the same board and a back plane board that uses electrical signal lines is used for the connection to the switch card. The present invention, however, disposes the switch and each network processor on the same board and disposes the switch having a large signal communication capacity closely to each network processor and uses a back plane board for the connection between each network processor having a relatively small signal communication capacity and each line card. This method can reduce the communication capacity of the back plane board, as well as the number of lines and the mounting capacity (mounting density) of the back plane board. In addition, the capacity of the connector used for the connection among the back plane board, the switch board, and another connector can also be reduced. Because of this packaging method, the network apparatus can be reduced more in size and improved more in packaging density. And, because the network processors and the switch are mounted on the same circuit board, packets can be forwarded between each network processor and the switch more efficiently than the conventional method.

1. A packet switching system, comprising:
a line card part having a function for transmitting/receiving a signal to/from an external communication line;
a switch card part for routing said signal inputted to said line card part; and
a back plane board for the connection between said line card and said switch card;
wherein said switch card part includes:
a first connector for transmitting/receiving a signal to/from said back plane board;
a plurality of network processors for carrying out a predetermined routing process for a signal received by said connector respectively; and
a switch connected among said plurality of network processors; and
wherein said line card part includes:
a second connector connected to said back plane board; and
a third connector connected to said external communication line.

2. The packet switching system according to claim 1,
wherein said first to third connectors are optical connectors; and
wherein said system further includes:
a first optical transceiver module disposed between said network processor and said first connector and used for photoelectric conversion; and
a plurality of optical signal lines for connecting between said first connector and each of said plurality of network processors respectively.

3. The packet switching system according to claim 2,
wherein said line card part includes:
processing means for converging or combining optical multiplexed signals;
a second optical transceiver module connected to said processing means and said second connector respectively; and
a third optical transceiver module connected between said processing means and said third connector; and
wherein said second optical transceiver module includes the same parts as those of said first optical transceiver module.

4. The packet switching system according to claim 1,
wherein said plurality of processors are disposed in a star-type pattern with respect to said switch.

5. The packet switching system according to claim 1,
wherein a plurality of said switches are provided and said plurality of network processors are disposed in a fat tree pattern with respect to said plurality of switches.

6. The packet switching system according to claim 1,
wherein said plurality of network processors and said switch are mounted in the same chip package.

7. The packet switching system according to claim 6,
wherein said first connector is mounted in said chip package.

8. The packet switching system according to claim 1,
wherein said system further includes a memory for storing a routing table and said memory is connected to said switch.

9. The packet switching system according to claim 1,
wherein said system further includes a plurality of lines for connecting said plurality of network processors to said switch; and
wherein said plurality of lines are almost the same in length.

10. The packet switching system according to claim 1,
wherein said system further includes a plurality of lines for connecting said plurality of network processors to said switch; and
wherein the traffic width of a signal path realized by said signal lines is almost the same among said plurality of lines.

11. The packet switching system according to claim 1,
wherein said system further includes a plurality of lines for connecting said plurality of network processors to said switch;
wherein said switch includes a plurality of pins to which said plurality of signal lines are connected; and
wherein the number of said pins to which said plurality of signal lines are connected is the same among said plurality of signal lines.

12. The packet switching system according to claim 2,
wherein said system further includes a plurality of signal lines for connecting said plurality of network processors to said switch; and
wherein all of said plurality of signal lines are shorter in length than said plurality of optical signal lines.

13. The packet switching system according to claim 2,
wherein said switch card includes a circuit board on which said first connector, said plurality of network processors, said switch, said first optical transceiver module, and said plurality of optical signal lines are mounted; and
wherein said plurality of optical signal lines are waveguides formed on said circuit board.

14. The packet switching system according to claim 1,
wherein said back plane board includes a plurality of optical line card connectors to which said line cards-are connected, an optical switch card connector to which said switch card part is connected, and a line for connecting said optical line card connector to said optical switch card connector; and
wherein said optical line card connectors are disposed symmetrically about and around said switch card on said back plane board.

15. The packet switching system according to claim 1,
wherein said system consists of said switch card part, said back plane board, and said plurality of line card parts; and
wherein the same parts are used for each of said plurality of line card parts.

16. A packet switching system, comprising:
a line card part including a physical line interface for transmitting/receiving a signal to/from an external communication line and a first circuit board on which said physical line interface is mounted;
a switch card part including a second circuit board on which a plurality of network processors for routing a signal inputted to said line card part and a switch for enabling said plurality of network processors to be connected to each another; and
a back plane board to which said first and second circuit boards are connected.
